(19) United States
(12) Patent Application Publication
(10) Pub. No.: US 2019/0240876 A1
(43) Pub. Date: Aug. 8, 2019

(54) COMPOSITE STRUCTURES

(71) Applicant: Bell Helicopter Textron Inc., Fort Worth, TX (US)

(72) Inventors: Wei-Yueh Lee, Arlington, TX (US); Paul K. Oldroyd, Azle, TX (US)

(21) Appl. No.: 15/891,111

(22) Filed: Feb. 7, 2018

(51) Int. Cl. B29C 35/08; B29C 70/44

(52) U.S. Cl. CPC B29C 35/0805; B29K 2105/0872; B29C 2035/0811; B29C 70/44

(57) ABSTRACT

A method is provided in one example embodiment and may include forming a ply stack on a tool, the ply stack comprising a plurality of plies; compacting the ply stack; and heating the ply stack during the compacting to form a composite structure, wherein the heating is caused by an electromagnetic inductive device or a radiative device. Compacting the ply stack can include encapsulating the ply stack within a bag and increasing a vacuum within the bag to increase external pressure on the bag and the ply stack.

### TECHNICAL FIELD

This disclosure relates in general to the field of aircraft and, more particularly, though not exclusively, to composite structures.

### BACKGROUND

Aircraft can include many components that can be constructed using composite materials. A composite material may be a combination of different materials integrated together to achieve certain structural properties and/or designs. It may be challenging, however, to manufacture aircraft components using composite materials in a cost and/or time efficient manner.

### SUMMARY

According to one aspect of the present disclosure, a method may be provided and may include forming a ply stack on a tool, the ply stack comprising a plurality of plies; compacting the ply stack; and heating the ply stack during the compacting to form a composite structure, wherein the heating is caused by an electromagnetic inductive device. Compacting the ply stack can include encapsulating the ply stack within a bag and increasing a vacuum within the bag to increase external pressure on the bag and the composite structure. In some instances, the electromagnetic inductive device can be a planar coil positioned to cover at least one of an outer surface or an inner surface of the ply stack. In still some instances, the electromagnetic inductive device can be a helical coil that is to encircle at least one of an outer surface or an inner surface of the ply stack.

In some cases, the method can include placing a foreign material layer on a surface of the ply stack prior to encapsulating the ply stack within the bag, wherein the foreign material layer is flexible and is at least one of a vacuum breather, a thermal insulator, and an electrical conductor. In still some cases, the method can include placing a foreign material layer on a surface of the ply stack prior to encapsulating the ply stack with in the bag, wherein the foreign material layer is hard and is at least one of a stiff or semi-stiff caul, a thermal insulator, and an electrical conductor.

In some cases, at least one ply of the ply stack can include an electrically conductive material. In some instances, the electrically conductive material can be at least one of a metal-based material or a carbon-based material. In still some cases, the electrically conductive material can be included within an uncured resin of the at least one ply. In still some cases, the electrically conductive material can be included within a fiber structure of the at least one ply. In still some instances, the bag can include an electrically conductive material. In still some cases, the method can include providing a releasable material along one or more outer surfaces of the ply stack, wherein the releasable material comprises an electrically conductive material. In still some cases, none of the plurality of plies may include an electrically conductive material, while the bag may include an electrically conductive material.

In some cases, the tool may be a first tool, and the method may further include providing a second tool that covers the composite structure; and curing the composite structure at another temperature that is different than a temperature associated with the heating performed during the compacting.

According to another aspect of the present disclosure, another method may be provided and may include forming a ply stack on a tool, the ply stack comprising a plurality of plies; compacting the ply stack; and heating the ply stack during the compacting to form a composite structure, wherein the heating is caused by a radiative device. Compacting the ply stack can include encapsulating the ply stack within a bag; and increasing a vacuum within the bag to increase external pressure on the bag.

In some cases, the bag can include a material that increases electromagnetic radiation absorption for the bag. In some cases, the radiative device can be one of one or more heat lamps; or one or more light emitting diodes. In some cases, the method can include applying a material along one or more surfaces of the ply stack, wherein the material increases electromagnetic radiation absorption for the ply stack along the one or more surfaces to which the material is applied, and the material is a spray on powder or liquid.

According to another aspect of the present disclosure, a system may be provided and may include a tool upon which a ply stack is formed; a bag to form a sealed volume around the tool and the ply stack; and a device to cause the ply stack to be heated using inductive or radiative heating. In various cases, at least one of the bag or at least one ply of the ply stack may include a conductive material; or at least one of the bag may be composed of a material that increases electromagnetic radiation absorption of the bag or at least one ply of the ply stack may be coated along at least one surface with a material that increases electromagnetic radiation absorption of the at least one ply.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements.

FIGS. 1A-1B are simplified schematic diagrams of an example aircraft, in accordance with certain embodiments.

FIG. 2 is a simplified flowchart illustrating example details associated with forming a composite structure, in accordance with certain embodiments.

FIGS. 3A-3E are simplified schematic diagrams illustrating example details that may be associated with forming a composite structure using hot compactions that include inductive or radiative heating, in accordance with certain embodiments.

FIGS. 4A-4D are simplified isometric view diagrams illustrating example details that may be associated with different electromagnetic inductive device configurations that may be used to provide induction heating, in accordance with certain embodiments.

FIGS. 5A-5C are simplified isometric view diagrams illustrating example details that may be associated with different radiative device configurations that may be used to provide radiative heating, in accordance with certain embodiments.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as ‘above’, ‘below’, ‘upper’, ‘lower’, ‘top’, ‘bottom’ or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature) of an element, operations, and/or conditions, the phrase ‘between X and Y’ represents a range that includes X and Y.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

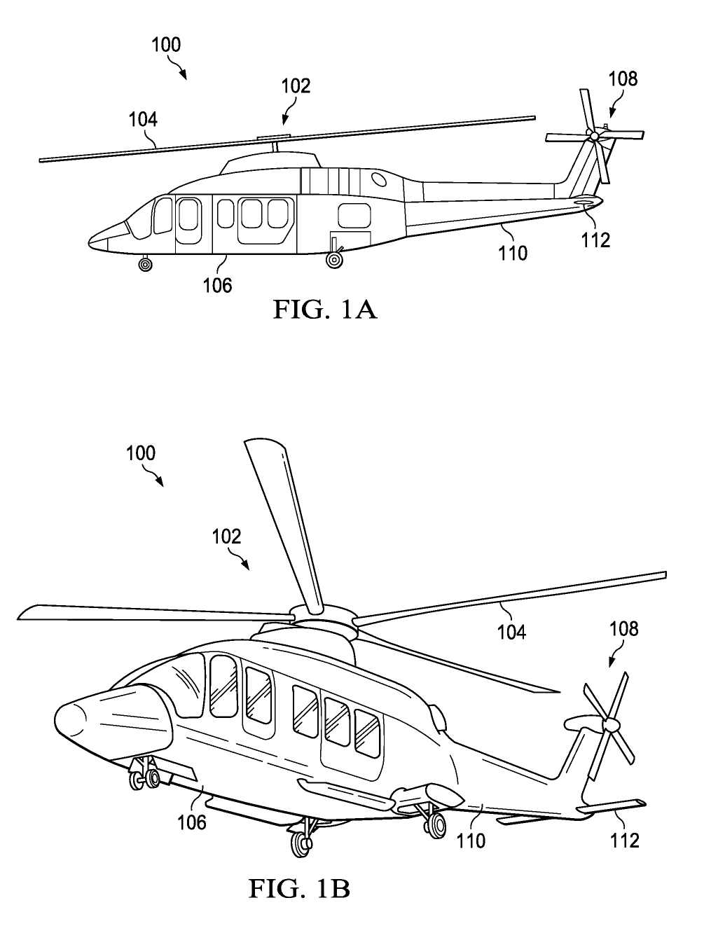

FIGS. 1A-1B illustrate an example embodiment of a rotorcraft 100. FIG. 1A portrays a side view of rotorcraft 100, while FIG. 1B portrays an isometric view of rotorcraft 100. Rotorcraft 100 includes a rotor system 102 with a plurality of rotor blades 104. The pitch of each rotor blade 104 can be managed or adjusted in order to selectively control direction, thrust, and lift of rotorcraft 100. Rotorcraft 100 further includes a fuselage 106, a tail rotor or anti-torque system 108, an empennage 110, and a tail structure 112. The fuselage 106 is the main body of the rotorcraft, which may include a cabin (e.g., for crew, passengers, and/or cargo) and/or may house certain mechanical and electrical components (e.g., engine(s), transmission, and/or flight controls). In the illustrated embodiment, tail structure 112 may be used as a horizontal stabilizer. Torque is supplied to rotor system 102 and anti-torque system 108 using at least one engine and at least one gearbox.

In some cases, certain components of rotorcraft 100 may be made from composite materials. A composite material is a combination of different materials integrated together to achieve certain structural and/or design properties. Stated differently, a composite material may be a combination of at least two different materials that, when they are in close proximity and function in combination with each other, enhance the capabilities that either material may possess alone. Composite materials can be integrated together to form three-dimensional composite structures. The properties of a three-dimensional composite structure are typically superior to the properties of the underlying materials individually. For example, certain composite materials may be lightweight yet relatively strong, rendering them particularly suitable for aircraft and other applications where weight and/or strength are critical to performance.

Many components of rotorcraft and other aircraft can be designed using composite materials including, but not limited to, flight control surfaces (sometimes referred to as ‘skins’), wings, fairings, spoilers, stabilizers, propellers, rotor blades, rotor yokes, engine blades, engine components, airframe structural components, spars, tubes, the fuselage, various interior components (e.g., floors, walls, fixtures), and so forth. As referred to herein in this Specification, the term ‘composite structure’ may include any part, element, component, device, etc. that may be formed (e.g., manufactured, fabricated, etc.) using multiple layers of composite materials. Layers of composite materials used in forming a composite structure are often referred to as plies or laminates, which can be configured (e.g., by hand or using a placement machine) into a ply or laminate stack and further processed to form the composite structure, as discussed for various embodiments described herein. As referred to herein, the terms ‘forming’, ‘fabricating’, and ‘manufacturing’ may be used interchangeably in reference to making a composite structure.

In some cases, composite materials that may be used in forming composite structures in accordance with embodiments described herein can be fiber reinforced composite materials. In general, a fiber reinforced composite material may be any composite that includes a fiber that is a basic load carrying member of a composite and a matrix (e.g., a resin, adhesive, etc.) that holds the composite together so that energy can be transferred among the fibers for the composite. Fibers for reinforced composite materials can include woven fabrics, unidirectional fibers, multidirectional fibers, and/or any combination thereof, which may or may not be implemented as one or more sheets of fibers for a composite material. In some instances, fibers for a reinforced composite material can be referred to as a ‘fiber system’. Examples of various fibers or fiber systems that may be included in a composite material that may be used in forming composite structures in accordance with embodiments described herein can include but not be limited to, carbon, boron, Kevlar®, glass (e.g., fiberglass), basalt, Dyneema®, metals (coated or uncoated), metal alloys (coated or uncoated), metal coated fibers, combinations thereof, or the like.

In some cases, a fiber system for a composite material can be disposed in an uncured resin or adhesive system, which may be in the form of a pre-impregnated (typically referred to using the term ‘prepreg’) composite material. Examples of a resin system that may be included in a composite material that may be used in forming composite structures in accordance with embodiments described herein can include, but not be limited to, a thermoset resin system such as polyester, plastic (e.g., bismaleide (BMI) plastic), epoxy; or a thermoplastic resin system (e.g., polyetheretherketone (PEEK), Polyetherkeytonekeytone (PEKK), Polyetherimide (PEI), etc.), or the like. One example adhesive system that may be included in a composite material that may be used in forming composite structures in accordance with embodiments described herein can include, but not be limited to, AF163 made by 3M®.

Various fiber reinforced composite materials that may be used in forming composite structures in accordance with embodiments described herein may include carbon fiber reinforced polymer (CFRP), HexPly 8552 made by Hexcel®, carbon fiber fabric prepreg plies (e.g., 3K carbon fiber fabric with either a Hexcel® F593, Ciba Geigy R922, Ciba Geigy R6376, Ciba Geigy M20, or thermoplastic resin system), boron fiber prepreg plies, fiberglass prepreg plies, or the like. In still some embodiments, another type of fiber reinforce composite material that may be used in forming composite structures in in accordance with embodiments described herein can be a metal matrix composite material. A metal matrix composite typically includes a higher melting temperature metal fiber (e.g., a metal or metal coated fiber) within a lower melting point structural metal matrix.

Uncured prepreg plies typically have air entrained in them. When forming composite structures, multiple layers prepreg plies are often assembled into a configuration (e.g., via a molding tool or the like) and the air is removed to ‘debulk’ and compact the plies. Traditionally, debulking of uncured prepreg plies can be performed using externally-applied mechanical pressure and human effort. Typically, vacuum systems or hydraulic equipment can be used to debulk uncured prepreg plies. In some cases, heat may be used during a ‘hot debulk’ or ‘hot compaction’ processing cycle (or cycles) to remove additional bulk from the plies that may not be removed by mechanical pressure alone and/or to ensure a proper fit in a molding tool. The heat can decrease viscosity of the resin system of a prepreg ply, which allows the resin to flow better and allow volatiles (e.g., any trapped gasses) to escape. Removing such volatiles can help to reduce defects such as voids, wrinkles (sometimes referred to as ‘marcels’), and/or porosity for cured composite structures. Such defects can decrease the strength of a composite structure. Heat is typically applied using an oven or autoclave.

While hot compactions are useful in fabricating high strength composite structures, performing such compactions typically involves stopping the fabrication process of an in process composite structure, applying mechanical pressure to the in process composite structure, and then moving the in process composite structure into an oven or autoclave. As referred to herein in this Specification, the term ‘in process’ may refer to an unfinished composite structure that is in the process or being fabricated into a final composite structure. In some cases, multiple hot compactions may be needed for multiple ply stacks in order to form a final composite structure. Each time an in process composite structure is moved into or out of a hydraulic press, an oven, or an autoclave, there is a risk that defects may be caused to the in process composite structure due to fibers and/or plies shifting during the moving.

Moreover, current hot compaction processes use conduction or convection heating in which heat is generated external to an in process composite structure (e.g., using an oven or autoclave) and then applied to the in process composite structure, typically through multiple barriers of a vacuum system (e.g., a sealing bag and one or more foreign material layer(s)). Conduction heating involves transferring heat to an object through physical contact and convection heating involves transferring heat to an object by the movement of gasses or liquids surrounding an object. Heating an in process composite structure through multiple barriers of a vacuum system using conduction or convection heating can be inefficient and time consuming, which can increase fabrication costs of composite structures.

The present disclosure describes various embodiments for providing in process hot compactions of composite materials to form composite structures. In accordance with at least one embodiment, a method of forming a composite structure may include forming a ply stack on a tool, such as a male mandrel, compacting the ply stack, and heating the ply stack during the compacting using an electromagnetic inductive device. The heating and compacting consolidates and bonds the plies together. In another embodiment, a method of forming a composite structure may include forming a ply stack on a tool, compacting the ply stack, and heating the ply stack during the compacting using a radiative device. In at least one embodiment, multiple ply stacks and multiple hot compactions may be used to form a composite structure. In at least one embodiment, heating and compacting as discussed for embodiments described herein may be provided without moving an in process composite structure from a fixed geographic location.

In accordance with embodiments discussed herein, compacting a ply stack may include using a vacuum system to evacuate gasses from plies of the ply stack. The vacuum system may include a sealing bag configured to encapsulate the ply stack, the tool, and at least one foreign material layer(s) positioned along a portion of at least one surface and/or at least one side of the ply stack (e.g., a surface of an outer ply of the ply stack that is not in contact with the tool). The sealing bag may be used to provide a sealed volume in which a vacuum can be drawn using a vacuum device (e.g., a vacuum pump) that may be coupled to the sealing bag using a port of the sealing bag or other coupling appropriate coupling means.

In general, induction heating involves injecting a high-frequency current through an electrical conductor (e.g., a copper coil) that is in proximity to another electrical conductor. The current generates a magnetic field around the coil and induces eddy currents in the other electrical conductor, which causes the other electrical conductor to heat up. In general, radiant heating involves transferring heat to an object using electromagnetic radiation (e.g., light).

For embodiments in which an electromagnetic inductive device is used to heat a ply stack, electrically conductive materials within and/or proximate to one or more plies of the ply stack may be utilized to heat the ply stack. For example, in some embodiments, a sealing bag may be composed of electrically conductive material. In some embodiments, one or more plies of a ply stack may include an electrically conductive material. For example, in some embodiments fibers of a ply may be made of an electrically conductive material and/or coated with an electrically conductive material. In some embodiments, the resin or adhesive system of a ply may include strands or ‘whiskers’ of electrically conductive material embedded therein and/or strands or whiskers of fibers coated in an electrically conductive material embedded therein. In still some embodiments, a ply may be a metal matrix composite including electrically conductive materials.

In still some embodiments, a peel ply, release film, or other intermediate releasable material that may include an electrically conductive material may be positioned along one or more surfaces of a ply stack. In some embodiments, an electromagnetic inductive device may be a planar coil that may be positioned proximate to at least one surface and/or at least one side of a ply stack. In other embodiments, an electromagnetic inductive device may be a helical coil that may be positioned to encircle a ply stack along at least two opposing planes (e.g., opposing top and bottom planes and at least two opposing side planes).

For embodiments in which a radiative device is used to heat a ply stack, materials that may increase the absorption of electromagnetic radiation may be provided. For example, in some embodiments, a sealing bag may be composed of a black or other dark colored material (e.g., a black body bag), which may increase the absorption of electromagnetic radiation by the sealing bag. In some embodiments, a material such as a liquid or a powder may be applied along one or more surfaces of a ply stack (e.g., surface(s) of an outer ply of a ply stack), which may increase the absorption of electromagnetic radiation for the ply stack.

Embodiments described throughout this disclosure may provide numerous technical advantages including, but not limited to, providing that an in process composite structure may remain in a fixed (or substantially fixed) geographic location during one or more hot compactions, which may reduce the risk of inducing defects into the in process composite structure; and/or providing for the ability to heat a ply stack by causing one or more plies of the ply stack to heat through induction heating or radiant heating, which may provide for more efficient heating of the ply stack in comparison to other forms of heating the ply stack.

Example embodiments associated with forming composite structures using in process hot compactions are described below with more particular reference to the remaining FIGURES. It should be appreciated that rotorcraft 100 of FIGS. 1A-1B is merely illustrative of a variety of aircraft in which composite structures may be used in accordance embodiments of the present disclosure. Other aircraft in which composite structures may be used can include, for example, fixed wing airplanes, hybrid aircraft, unmanned aircraft, gyrocopters, a variety of helicopter configurations, and drones, among other examples. Moreover, it should be appreciated that even though composite structures may be used in aircraft, composite structures as discussed for various embodiments described herein may also be used in a variety of industries including, but not limited to, aerospace, non-aircraft transportation (e.g., boats, automobiles, busses, etc.), railway transportation, consumer electronics, sporting equipment, or the like.

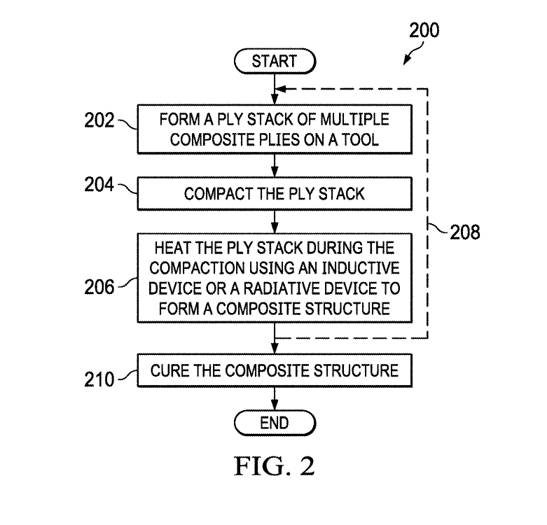

FIG. 2 is a simplified flowchart 200 illustrating example details associated with forming a composite structure, in accordance with certain embodiments. In at least one embodiment, the flowchart may begin at block 202 by forming a ply stack of multiple composite plies on a tool. The composite plies may be composed of any materials as discussed herein. The composite plies may stacked on top of each other (e.g., by a human or by a placement machine) on the tool to form the ply stack. In various embodiments, the tool may be a male mandrel or other molding tool. In some embodiments, the tool may define a shape or other configuration of the composite structure that to be formed; however, in other embodiments the tool may not define a shape or other configuration of the composite structure that is to be formed (e.g., the composite structure may be machined following fabrication to form a desired shape or configuration).

The ply stack may have an inner surface, an outer surface, and a number of side surfaces (e.g., at the edges of the ply stack). The inner surface of the ply stack may represent the interior of the composite structure that is to be formed. The outer surface may either represent the exterior of the composites structure that is to be formed or may represent an intermediate outer surface upon which another ply stack may be formed (following heating and compacting) to further fabricate the composite structure. In some embodiments, a peel ply, release film, or other intermediate releasable material may be positioned between a first ply of the ply stack and the tool. For example, the intermediate releasable material may be in direct contact with the tool on one side of the material and in direct contact with the first ply of the ply stack on an opposing side of the material such that the material may be ‘sandwiched’ between the ply stack and the tool. In some embodiments, an intermediate releasable material may be positioned along the outer surface of a ply stack in addition to or in lieu of positioning the intermediate material between the ply stack and the tool.

In some embodiments, an intermediate releasable material that may be positioned along one or more surfaces of a composite structure may help to protect surfaces of the structure from contamination, defects, damage or other like during fabrication for an in process composite structure and/or during subsequent processes (e.g., transport, machining, etc.) of a cured composite structure. In some embodiments, an intermediate releasable material that may be used in accordance with embodiments described herein may be composed of nylon, polyester, or similar material. In still some embodiments, an intermediate releasable material that may be used in accordance with embodiments described herein may be composed of and/or include an electrically conductive material (e.g., carbon, boron, metal, metal alloys, etc.), which may facilitate heating a ply stack during in process compactions of a composite structure via an inductive heating device. In still some embodiments, an intermediate releasable material that may be used in accordance with embodiments described herein may be composed of materials (e.g., black or dark colored materials) that may increase the absorption of electromagnetic radiation, which may facilitate heating a ply stack during in process compactions of a composite structure via a radiative heating device.

The flowchart may proceed to block 204 by compacting the ply stack. In at least one embodiment, compacting the ply stack may include using a vacuum system to evacuate gasses from the uncured plies of the ply stack. The vacuum system may include a sealing bag configured to encapsulate the ply stack and at least one foreign material layer (that is not part of the ply stack that is to form the composite structure) placed or otherwise positioned along a portion of at least one surface and/or at least one side of the ply stack (e.g., a surface of an outer ply of the ply stack that is not in contact with the tool). In various embodiments, the layer can be a flexible or hard (stiff or semi-stiff) foreign material layer and may be any combination of a vacuum breather, a thermal insulator, an electrical conductor, and/or a caul sheet or plate (which may have any shape). The sealing bag can be secured to the tool on which the ply stack is formed to provide a sealed volume in which a vacuum can be drawn using a vacuum device (e.g., a vacuum pump) that may be coupled to the sealing bag using a port of the sealing bag or other coupling appropriate coupling means. In various embodiments, the sealed volume may be placed under a vacuum level of between one (1) inch to 28 inches of mercury to debulk and compact the ply stack. Increasing the vacuum level within the bag decreases pressure within the bag and results in increasing pressure outside the bag; thereby creating a subsequent increase in pressure on the ply stack due to the differential pressure between ambient pressure outside the bag and the vacuum inside the bag. In some embodiments, multiple vacuum levels may be used during compaction of the ply stack.

In general, a vacuum breather may be a porous material such one or more sheets of Teflon® or the like that may facilitate the evacuation of volatiles from the ply stack during compaction of the ply stack. In general, caul plates or sheets of any size and/or shape, which can be stiff or semi-stiff, can be used to transmit pressure and help to provide a smooth surface for a composite structure. In some embodiments, at least one foreign material layer may include and/or be formed of electrically conductive materials. In still some embodiments, at least one foreign material layer may include and/or be formed of electrically conductive materials. In some embodiments, at least one foreign material layer may be positioned along a surface of an outer (topmost) ply of the ply stack between the sealing bag and the outer ply. In still some embodiments, foreign material layer(s) may be positioned along one or more sides of the ply stack.

The flowchart may proceed to block 206 by heating the ply stack during the compacting (206) using an electromagnetic inductive device or a radiative device to form a composite structure. The formed composite structure may be considered an in process composite structure until the flowchart is completed. Although flowchart 200 illustrates sequential flows between 204 and 206, it is to be understood that the compacting (204) and the heating (206) may be performed in parallel in accordance with embodiments described herein. In at least one embodiment, the ply stack is heated to a temperature wherein the matrix system viscosity is reduced to a point that volatile evacuation is enabled. In at least one embodiment, the ply stack may be heated to a temperature greater than 85 degrees Fahrenheit. In some embodiments, the ply stack may be heated to temperatures greater than 450 degrees Fahrenheit, depending on the materials of the composite plies. For example, if the ply stack is formed of metal matrix composite plies, the stack may be heated to temperatures as high as 600 degrees Fahrenheit or more.

The compacting (204) and the heating (206) may be maintained for a period of time that is sufficient to debulk and compact the ply stack to form the composite structure. In various embodiments, the period of time may range between 30 minutes and several hours, depending on various processing variables including, but not limited to, the beginning thickness of the ply stack, the materials of the composite plies, the desired shape or configuration of the composite structure, the device (e.g., inductive or radiative) used to heat the ply stack, among others. In some embodiments, hot compactions of an in process composite structure may be performed while the in process composite structure remains in a fixed geographic location (e.g., it is not moved into an oven or autoclave).

In some cases, the forming (202), compacting (204), and heating (206) may be repeated (208) for embodiments in which multiple ply stacks may be used to form a composite structure. For embodiments in which the forming (202), compacting (204), and heating (206) may be repeated (208), the sealing bag and at least one foreign material layer(s) may be removed from the in process composite structure and tool prior to forming (202) a subsequent ply stack on a previously compacted ply stack and then subsequently re-encapsulating the stacks and the tool with a sealing bag (e.g., a same or different sealing bag as used for a previous ply stack) in order to perform subsequent hot compactions for the in process composite structure.

The flow chart may proceed to block 210 by curing the in process composite structure. In some embodiments, the curing (210) may include configuring the composite structure inside another tool or mold positioned along the outer surface(s) of the in process composite structure. In at least one embodiment, the ply stack may be heated to a temperature at which the matrix experiences a phase change. In at least one embodiment, the ply stack may be heated to a temperature at which the matrix experiences a chemical change (e.g., polymerization). In some embodiments, the curing (210) may include heating the in process composite structure to a temperature greater than the temperature used during the hot compactions (204, 206) for a period of time that is sufficient to cure resin of the structure; however, in other embodiments, the curing may include heating the in process composite structure to a temperature less than the temperature used during the hot compactions for a period of time that is sufficient to cure resin of the structure. In various embodiments, the period of time for the curing may range between 30 minutes and several hours. At this point, the flowchart may be completed. In some embodiments, however, the flowchart may restart and/or certain blocks may be repeated.

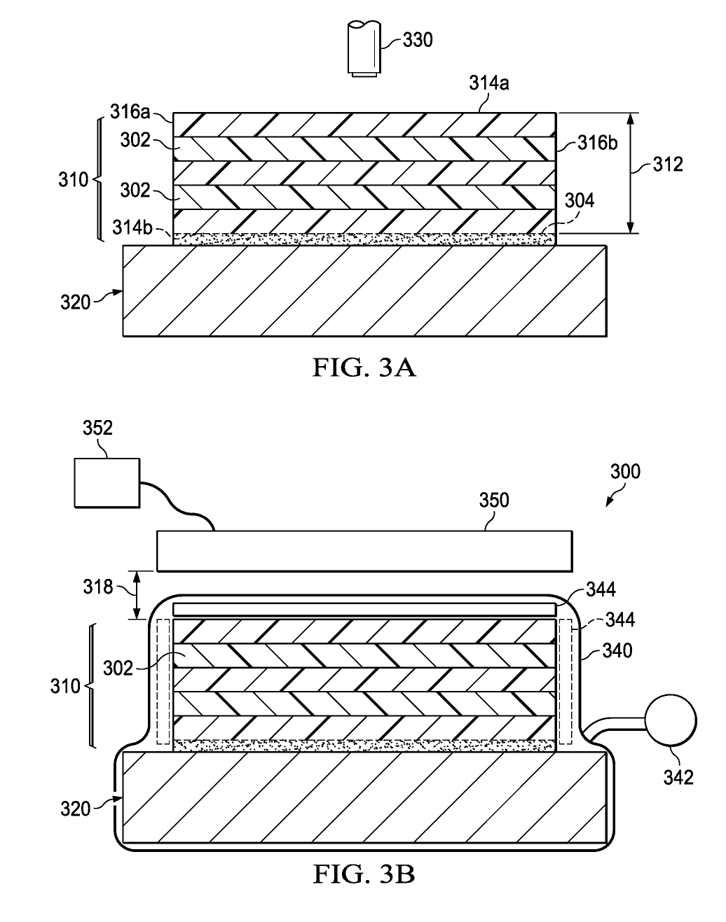

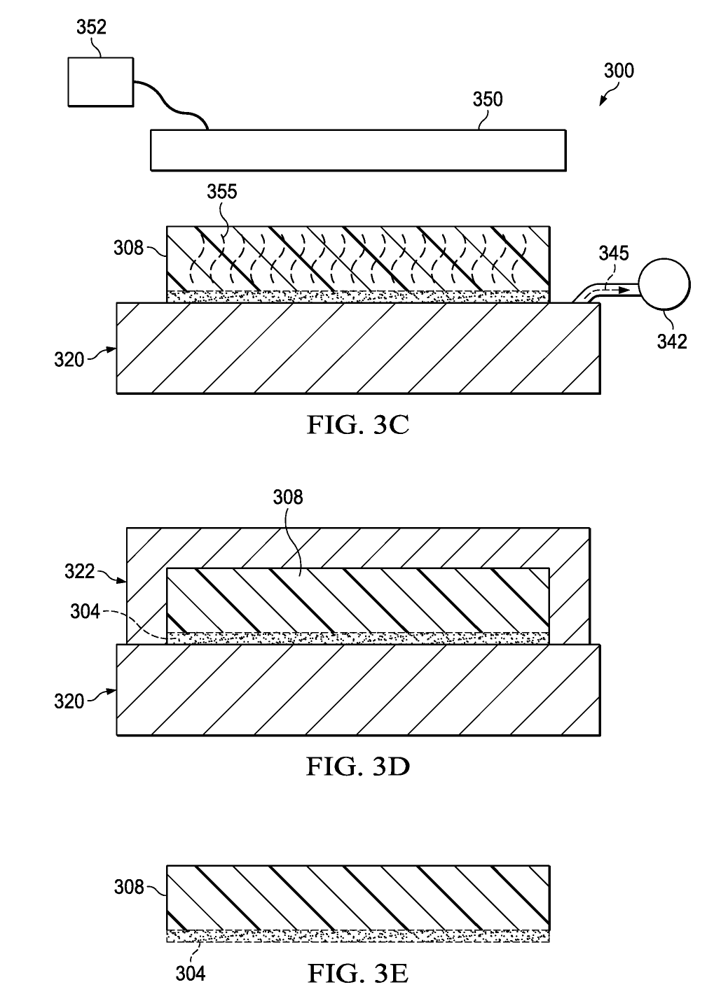

FIGS. 3A-3E are simplified schematic diagrams illustrating example details that may be associated with forming a composite structure using hot compactions that include inductive or radiative heating, in accordance with certain embodiments. Referring to FIG. 3A, a ply stack 310 including multiple plies 302 may be formed (e.g., by a human or by a placement machine 330) on a tool 320. The ply stack 310 may have an overall (beginning) thickness 312. In various embodiments, the overall (beginning) thickness 312 of the ply stack 310 may range between ⅛ inch and 4 inches. The ply stack 310 may also have an outer (top) surface 314a, an inner (bottom) surface 314b, and a number of sides 316a, 316b. It is to be understood that the ply stack 310 can include other sides, which are not labeled in FIG. 3A for sake of brevity. In some embodiments, a releasable material 304, as discussed herein, may be configured between the ply stack 310 and the tool 320. In some embodiments, a releasable material may be configured on the outer surface 314a and/or one or more side(s) 316a, 316b of the ply stack 310. Some of the elements illustrated in FIG. 3A are included in other ones of the accompanying FIGURES; the discussion of these elements is not repeated when discussing these FIGURES and any of these elements may take any of the forms disclosed herein.

The example ply stack 310 and tool 320 shapes and configurations as well as the number of plies 302 illustrated for FIGS. 3A-3E are provided for illustrative purpose and are not meant to limit the broad scope of the present disclosure. It is to be understood that virtually any shape and configuration of a ply stack and/or tool on which the ply stack is formed and/or the number of plies in the ply stack may be envisioned and, thus, are clearly within the scope of the present disclosure.

Referring to FIG. 3B, the ply stack 310 and tool 320 may be encapsulated in a sealing bag 340. A device 350 capable of causing the ply stack 310 to be heated through inductive or radiative heating may be positioned proximate to at least one surface and/or at least one side of the ply stack 310 at a distance 318, as discussed below. In some embodiments, the device 350 may be an electromagnetic inductive device (e.g., a metal coil) capable of causing the ply stack 310 to be heated through inductive means; however, in other embodiments, the device 350 may be a radiative device (e.g., an electromagnetic radiation emitting device such as a light source) capable of causing the ply stack to be heated through radiative means.

Although the device 350 for the embodiment of FIG. 3B is positioned proximate to the outer surface 314a of the ply stack 310, it is to be understood that the device 350 may also be positioned proximate to one or more side(s) (e.g., side 316a and/or side 316b) of the ply stack 310, and/or the inner surface 314b, in various embodiments, which may cover, encircle, or otherwise be near outer and/or inner surfaces of the ply stack 310. For example, for a tubular-shaped composite structure, the device 350 may cover the outside and/or inside surface of the structure. In still some embodiments, the device 350 may fully encircle both the ply stack 310 and the tool 320 along at least two opposing planes (e.g., opposing top and bottom planes and at least two opposing side planes of the ply stack 310). For example, for a tubular-shaped structure, the device may encircle the outside and/or inside of the structure. In some embodiments, the device 350 may be coupled to one or more arm(s) or other positioning apparatus(es) (not shown) that may allow the device 350 to be configured in one or more position(s) relative to the ply stack 310, depending on implementations and/or applications.

The sealing bag 340 may be coupled to a vacuum device 342 via a hose coupled to a port (not shown) of the sealing bag 340 or other appropriate means. The sealing bag 340 may provide a sealed volume including the ply stack 310 and a vacuum can be drawn on the ply stack 310 using the vacuum device 342. In some embodiments, the sealing bag 340 may fully encapsulate the tool 320; however, in other embodiments, the sealing bag 340 may only partially cover the tool 320, in which embodiments the sealing bag 340 may be secured to the tool 320 using sealant tape or the like (not shown). At least one foreign material layer 344 may be placed between the sealing bag 340 and the outer surface of the ply stack 310. In some embodiments, at least one foreign material layer(s) 344 may also be used on the sides of the ply stack 310. In some embodiments, a thermocouple or other temperature sensitive device (not shown) may be included inside the sealing bag 340 (e.g., between the foreign material layer(s) 344 and the sealing bag 340) to measure the temperature within the sealing bag 340. In some embodiments, multiple thermocouples or temperature sensing devices can be included inside the sealing bag 340 at various locations to determine temperatures at the locations.

In various embodiments, the vacuum device 342 may be a vacuum pump or the like capable of providing a vacuum level within the sealing bag 340 between 1 and 28 inches of mercury. The device 350 may be connected to a power source 352. The power source 352 may be capable of providing power for the device 350 in order to heat the ply stack 310 using inductive or radiative heating. For embodiments in which the device 350 is an electromagnetic inductive device, the power source 352 may be capable of generating and injecting a current having a given frequency and amplitude into the device 350. In some embodiments in which the device 350 is an electromagnetic inductive device, the power source 352 may include a magnetic flux controller. In various embodiments, the power source 352 may be capable of generating current having frequencies between 50 hertz (Hz) and 1 megahertz (MHz) and powers between 1 kilowatts (KW) and 1 megawatts (MW).

In at least one embodiment, the tool 320, the sealing bag 340, the vacuum device 342, the foreign material layer(s) 344, the device 350, and the power source 352 may represent a fabrication system 300 capable of performing in process hot compactions of a ply stack (e.g., ply stack 310) to form a composite structure using inductive or radiative heating.

As illustrated in the embodiment of FIG. 3B, the device 350 may be positioned at a distance 318 from the at least one surface and/or at least one side of the ply stack 310. In various embodiments, the distance 318 may range between 0.1 inches and 12 inches or greater and may vary depending on whether the device 350 is an inductive or radiative device, the configuration of the device 350 (e.g., number, length, spacing, and/or gauge of coils and/or coil windings of electromagnetic inductive devices; number, size and/or spacing of electromagnetic radiation emitting devices; etc.), operating characteristics of the device 350 (e.g., current frequency, amplitude, and/or power; electromagnetic radiation wattage, lumens, and/or wavelength; etc.), thickness 312 of the ply stack 310, materials of the plies 302 of the ply stack 310, materials of the sealing bag 340, materials of the foreign material layer(s) 344, materials and/or thickness of the tool 320, combinations thereof, or the like.

Referring to FIG. 3C, the ply stack 310 may be heated 355 (as illustrated by the dashed-squiggle lines) to a desired temperature (or temperatures) via device 350 and volatiles of the plies may be evacuated 345 (as illustrated by the dashed-line arrow) to form a debulked and compacted composite structure 308. In some embodiments, the temperature of the ply stack may be increased gradually over a period of time until the desired temperature(s) may be reached.

For embodiments in which the device 350 is an electromagnetic inductive device, any combination of the sealing bag 340, one or more plies 302 of the ply stack 310, the releasable material 304 (if used), one or more foreign material layer(s) 344, and/or the tool 320 may include a conductive material, as discussed herein, which may cause the ply stack 310 to be heated to the desired temperature(s). In at least one embodiment, an electrically conductive material that may be included in one or more elements as discussed herein, may be an inefficient electrical conductor (e.g., having a high resistance), which may facilitate heating a ply stack. All electrically conductive materials may be inductively heated; however, ferromagnetic materials (e.g., iron, steel, etc.) are more susceptible to inductive heating than non-ferromagnetic materials (e.g., aluminum, copper, carbon, etc.).

For embodiments in which the device 350 is a radiative device, any combination of the sealing bag 340, one or more plies 302 of the ply stack 310, the releasable material 304 (if used), the foreign material layer(s) 344, and/or the tool 320 may include a material that may increase the absorption of electromagnetic radiation that may be received from the radiative device, as discussed herein, which may cause the ply stack 310 to be heated to the desired temperature(s). In some embodiments, the ply stack 310 may be coated with a liquid or powder that may increase the absorption of electromagnetic radiation by the ply stack 310 that may be received from a radiative device and/or that may increase the tackiness of the surfaces and/or sides of the ply stack 310.

Referring to FIG. 3D, the device 350 may be moved away from the composite structure, the sealing bag 340 and vacuum device 342 may be removed, and another tool 322 may be positioned along the outer surface and sides of the composite structure 308 and the composite structure 308 may be cured. In some embodiments, the curing can be performed via an oven or autoclave. However, in some embodiments, electromagnetic waves provided via electromagnetic inductive or radiative heating may be capable of penetrating a tool and/or mold, for example, if the tool and/or mold is composed of plastic, glass, etc. or is a fiber-reinforced or particulate reinforced composite mold. Thus, in some embodiments, electromagnetic or radiative heating (e.g. via device 350) may be used to cure the composite structure 308. For the embodiment of FIGS. 3D-3E, tool 320 may be referred to as a first tool 320 and tool 322 may be referred to as a second tool 322. In various embodiments, the composite structure 308 may be cured by heating the structure to an elevated temperature, which may be higher or lower than the temperature(s) used during hot compaction(s), for a period of time.

Referring to FIG. 3E, the first tool 320 and the second tool 322 may be removed following the curing. The cured composite structure 308 may be further machined as desired.

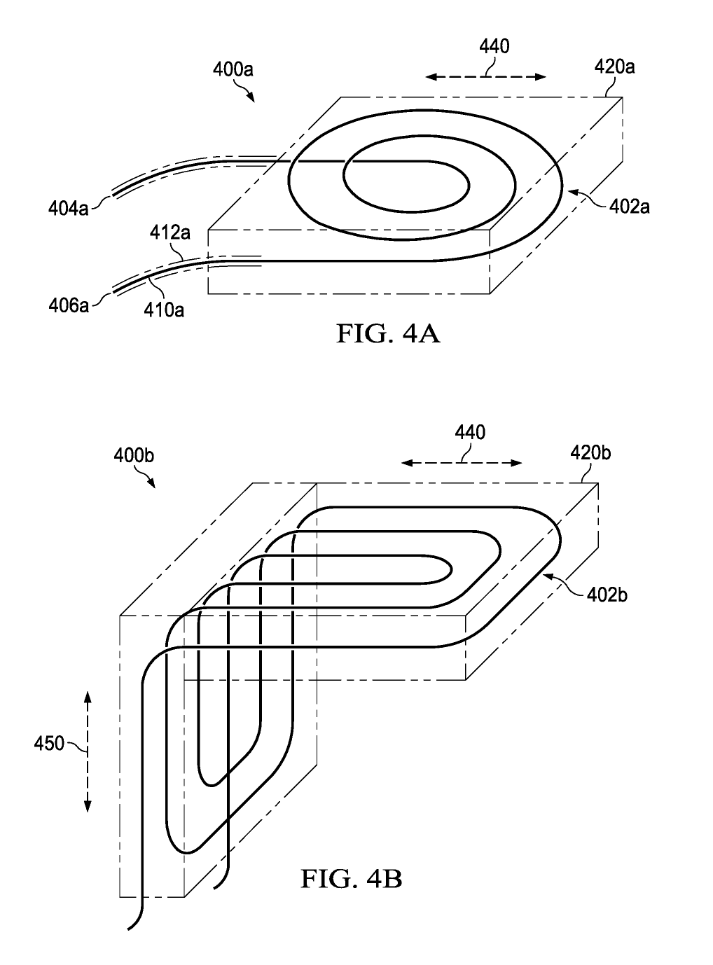

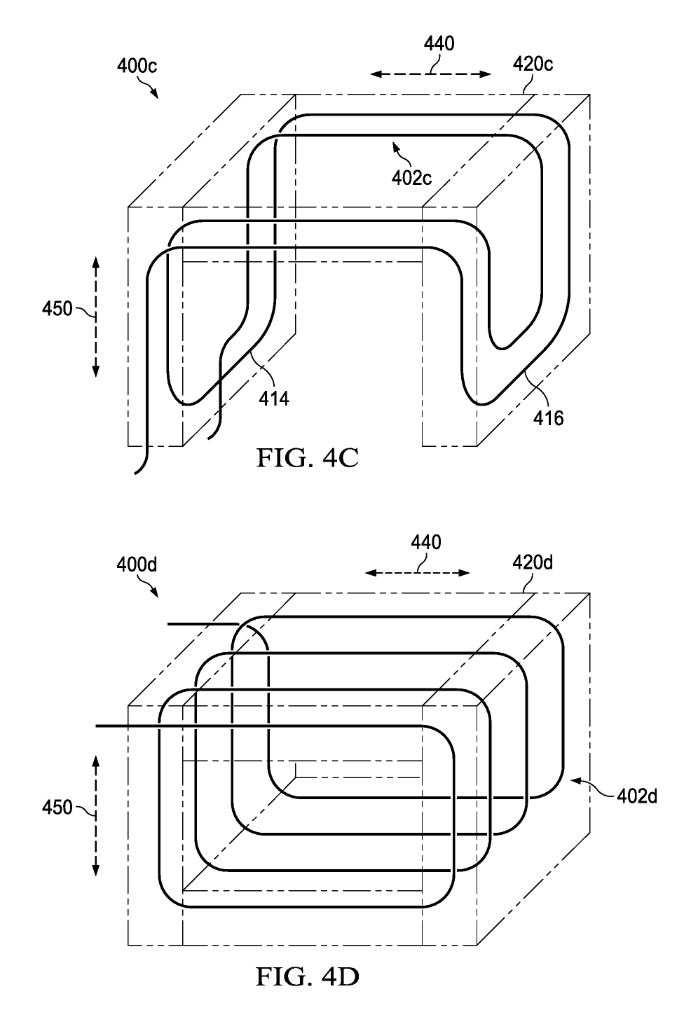

FIGS. 4A-4D are simplified isometric view diagrams illustrating example details that may be associated with different electromagnetic inductive device configurations that may be used to provide induction heating, in accordance with certain embodiments. For FIGS. 4A-4C, different planar configurations of electromagnetic inductive devices 400a-400c are illustrated. For FIG. 4D, a helical configuration of an electromagnetic inductive device 400d is illustrated.

Referring to FIG. 4A, electromagnetic inductive device 400a may include a conductive coil 402a that is configured in a planar manner along one plane 440 (as illustrated by the dashed-line) to cover outer and/or inner surfaces of an in process composite structure. In at least one embodiment, the coil 402a may include at least one conductor 410a (e.g., a copper wire) encapsulated in an insulating material 412a (e.g., plastic, fabric, etc.). For sake of brevity, the insulating material 412a is only illustrated for a portion of the at least one conductor 410a. The coil 402a may include any size, shape, and/or number of coil windings that may depend on the size of the device 400a, the conductor 410a gauge and/or type, operating characteristics (e.g., frequency, amplitude, power, etc.) of the coil 402a, or other similar considerations, in accordance with certain embodiments. The coil 402a may have two ends 404a, 406a that may be used to electrically connect the coil 402a to a power source (e.g., power source 352 as illustrated in FIGS. 3A-3B). In at least one embodiment, the coil 402a may be enclosed within a cavity 420a, which may be composed of an insulating material (e.g., not electrically conductive). The cavity 420a may provide structural support for the coil 402a.

Referring to FIG. 4B, electromagnetic inductive device 400b may include a conductive coil 402b that is configured in a planar manner along two planes 440 and 450 to cover outer and/or inner surfaces of an in process composite structure. The at least one conductor, insulating material, and ends of coil 402b are not labeled in FIG. 4B for sake of brevity. The coil 402b may include any size, shape, and/or number of windings that may depend on the size of the device 400b, the conductor gauge and/or type, operating characteristics (e.g., frequency, amplitude, power etc.) of the coil 402b, or other similar considerations, in accordance with certain embodiments. In at least one embodiment, the coil 402b may be enclosed within a cavity 420b, which may be composed of an insulating material (e.g., not electrically conductive). In some embodiment, sides of the cavity 420b may be hinged or may be otherwise flexible to allow the cavity 420b to be configured into multiple shapes.

Referring to FIG. 4C, electromagnetic inductive device 400c may include a conductive coil 402c that is configured in a planar manner along planes 440 and 450 such that two sides of the coil 402c along plane 450 may be configured opposite each other to cover outer and/or inner surfaces of an in process composite structure. For example, the coil 402c may have a first side 414 that may be configured opposite to a second side 416 of the coil 402c. The at least one conductor, insulating material, and ends of coil 402c are not labeled in FIG. 4C for sake of brevity. The coil 402c may include any size, shape, and/or number of windings that may depend on the size of the device 400c, the conductor gauge and/or type, operating characteristics (e.g., frequency, amplitude, power, etc.) of the coil 402c, or other similar considerations, in accordance with certain embodiments. In at least one embodiment, the coil 402c may be enclosed within a cavity 420c, which may be composed of an insulating material (e.g., not electrically conductive). In some embodiment, sides of the cavity 420c may be hinged or may be otherwise flexible to allow the cavity 420c to be configured into multiple shapes.

Although the electromagnetic inductive device configurations illustrated in FIGS. 4A-4C illustrate devices having one, two, or three sides, it is to be understood that some configurations may include four or more sides, depending on implementation and/or application.

Referring to FIG. 4D, electromagnetic inductive device 400d may include a conductive coil 402d that is configured in a helical manner such that it may fully encircle an in process composite structure (e.g., outer and/or inner surfaces of an in process composite structure) and/or tool along opposing sides of planes 440 and 450. The at least one conductor, insulating material, and ends of coil 402d are not labeled in FIG. 4D for sake of brevity. The coil 402d may include any size, shape, and/or number of windings that may depend on the size of the device 400d, the conductor gauge and/or type, operating characteristics (e.g., frequency, amplitude, power, etc.) of the coil 402b, or other similar considerations, in accordance with certain embodiments. In at least one embodiment, the coil 402d may be enclosed within a cavity 420d, which may be composed of an insulating material (e.g., not electrically conductive). In some embodiment, sides of the cavity 420d may be hinged or may be otherwise flexible to allow the cavity 420d to be configured into multiple shapes.

In various embodiments, conductors that may be used in an electromagnetic inductive device (e.g., any of electromagnetic inductive devices 400a-400d) may be composed of copper, aluminum, nickel, gold, a metal alloy, or combinations thereof. In some embodiments, conductors that may be used in an electromagnetic inductive device may be plated. In various embodiments, conductors that may be used in an inductive device may be solid core or hollow core and may vary in weight density, may be stranded with varying wire gauge, may be weaved or meshed with varying weight density, may be particlized of varying particle size and volume density, combinations thereof, or the like. In various embodiments, any cavity of an electromagnetic inductive device (e.g., any of cavities 420a-420d) may be coupled to arm(s) or other positioning device(s) (not shown) that may allow a corresponding inductive device to be configured in one or more position(s), depending on implementations and/or applications.

The electromagnetic inductive device configurations illustrated in FIGS. 4A-4D are only a few of the many possible electromagnetic inductive device configurations that may be used in a fabrication system (e.g., fabrication system 300 of FIG. 3) in accordance with embodiments described herein and are not meant to limit the broad scope of the present disclosure. Virtually any other electromagnetic inductive device configurations may be provided using similar means and methods as those described herein and, thus, are clearly within the scope of the present disclosure.

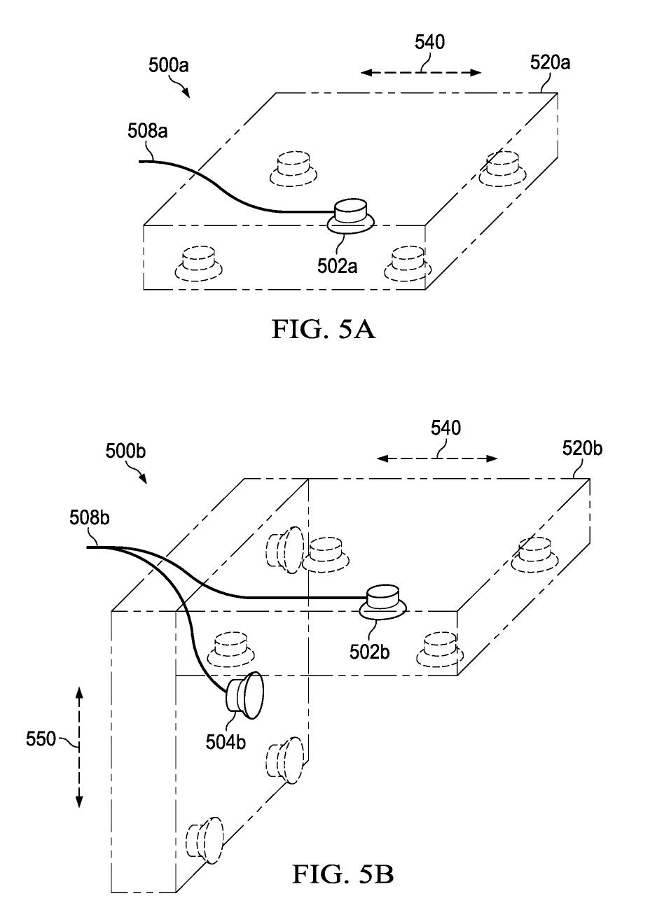

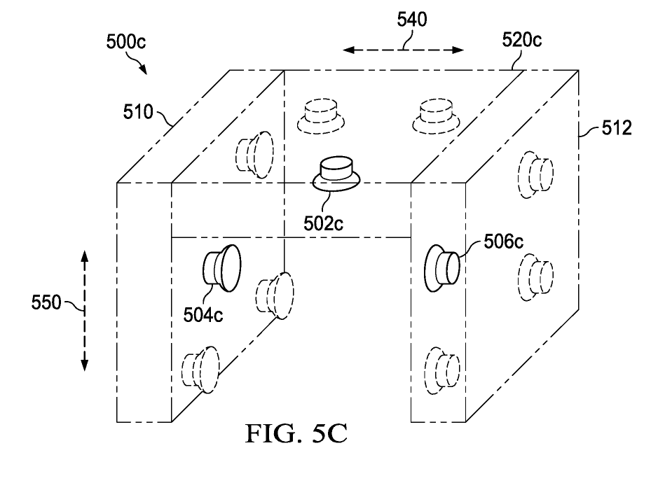

FIGS. 5A-5C are simplified isometric view diagrams illustrating example details that may be associated with different radiative device configurations that may be used to provide radiative heating, in accordance with certain embodiments. For FIGS. 5A-5C, different configurations of radiative devices 500a-500c are illustrated.

Referring to FIG. 5A, radiative device 500a may include at least one electromagnetic radiation emitting device 502a that is configured along a plane 540 (as illustrated by the dashed-line) to emit electromagnetic radiation approximately perpendicular (e.g., down, up, or diagonal) to the plane 540. The at least one electromagnetic radiation emitting device 502a may be connected to a power source via a conductive cable 508a. In various embodiments, the electromagnetic radiation emitting device 502a may be a heat lamp, a light bulb, a Light Emitting Diode (LED), an Infrared (IR) transmitter, a microwave transmitter or oven, combinations thereof, or the like. In various embodiments, any, size, shape, number and/or configuration of electromagnetic radiation emitting device(s) 502a may be configured along the plane 540 and may depend on the shape, size, operating characteristics, etc. of the electromagnetic radiation emitting device(s) 502a. In some embodiments, one or more of multiple electromagnetic radiation emitting device(s) 502a that may be configured for radiative device 500a may be configured to be selectively turned on or off, may be configured to emit different levels of electromagnetic radiation, and/or may be otherwise selectively configured depending on implementation and/or application.

In at least one embodiment, the at least one electromagnetic radiation emitting device 502a may be configured in a support structure 520a. The support structure 520a may provide a housing in which the electromagnetic radiation emitting device 502a may be mounted. In at least one embodiment, the support structure 520a may be coated with a reflective material (not shown) along a surface associated with the at least one electromagnetic radiation emitting device 502a, which may aid in directing or otherwise focusing electromagnetic radiation towards an in process composite structure.

Referring to FIG. 5B, radiative device 500b may include at least one electromagnetic radiation emitting device 502b configured along plane 540 (as illustrated by the dashed-line) to emit electromagnetic approximately perpendicular (e.g., down, up, or diagonally) to the plane 540 and at least one other electromagnetic radiation emitting device 504b configured along another plane 550 to emit electromagnetic radiation approximately perpendicular (e.g., left, right, or diagonal) to the plane 550. The electromagnetic radiation emitting devices 502b, 504b may be connected to a power source via a conductive cable (or cables) 508b. The electromagnetic radiation emitting devices 502b, 504b may be any electromagnetic radiation emitting devices, or combinations thereof, in accordance with various embodiments as discussed herein. In various embodiments, any, size, shape, number and/or configuration of electromagnetic radiation emitting device(s) 502b may be configured along the plane 540 and may depend on the shape, size, operating characteristics, etc. of the electromagnetic radiation emitting device(s) 502b. In various embodiments, any, size, shape, number and/or configuration of electromagnetic radiation emitting device(s) 504b may be configured along the plane 550 and may depend on the shape, size, operating characteristics, etc. of the electromagnetic radiation emitting device(s) 504b. In some embodiments, one or more of multiple electromagnetic radiation emitting devices 502b and/or 504b that may be configured for radiative device 500b may be configured to be selectively turned on or off, may be configured to emit different levels of electromagnetic radiation, and/or may be otherwise selectively configured depending on implementation and/or application.

In at least one embodiment, the electromagnetic radiation emitting devices 502b, 504b may be configured in a support structure 520b. In some embodiments, sides of the support structure 520b may be hinged or may be otherwise flexible to allow the support structure 520b to be configured into multiple shapes. In at least one embodiment, the support structure may be coated with a reflective material (not shown) along a surface associated with each electromagnetic radiation emitting device 502b, 504b which may aid in directing or otherwise focusing electromagnetic radiation towards an in process composite structure.

Referring to FIG. 5C, radiative device 500c may include at least one electromagnetic radiation emitting device 502c configured along plane 540 (as illustrated by the dashed-line) to emit electromagnetic approximately perpendicular (e.g., down, up, or diagonal) to the plane 540, at least one electromagnetic radiation emitting device 504c configured on a first side 510 of the radiative device 500c along plane 550 to emit electromagnetic radiation approximately perpendicular (e.g., left, right, or diagonal) to the plane 550, and at least one other electromagnetic radiation emitting device 506c configured along an opposing second side 512 of the radiative device 500c to emit electromagnetic radiation approximately perpendicular (e.g., left, right, or diagonally) to the plane 550. The electromagnetic radiation emitting devices 502c, 504c, 506c may be connected to a power source via a conductive cable (or cables), which is not shown in FIG. 5C for sake of brevity. The electromagnetic radiation emitting devices 502c, 504c, 506c may be any electromagnetic radiation emitting devices, or combinations thereof, in accordance with various embodiments as discussed herein.

In various embodiments, any, size, shape, number and/or configuration of electromagnetic radiation emitting device(s) 502c may be configured along the plane 540 and may depend on the shape, size, operating characteristics, etc. of the electromagnetic radiation emitting device(s) 502c. In various embodiments, any, size, shape, number and/or configuration of electromagnetic radiation emitting device(s) 504c may be configured along the plane 550 along the first side 510 and may depend on the shape, size, operating characteristics, etc. of the electromagnetic radiation emitting device(s) 504c. In various embodiments, any, size, shape, number and/or configuration of electromagnetic radiation emitting device(s) 506c may be configured along the plane 550 along the second side 512 and may depend on the shape, size, operating characteristics, etc. of the electromagnetic radiation emitting device(s) 506c.

In some embodiments, one or more of multiple electromagnetic radiation emitting devices 502c, 504c, and/or 506c that may be configured for radiative device 500c may be configured to be selectively turned on or off, may be configured to emit different levels of electromagnetic radiation, and/or may be otherwise selectively configured depending on implementation and/or application.

In at least one embodiment, the electromagnetic radiation emitting devices 502c, 504c, 506c may be configured in a support structure 520c. In some embodiment, sides of the support structure 520c may be hinged or may be otherwise flexible to allow the support structure 520c to be configured into multiple shapes. In at least one embodiment, the support structure 520c may be coated with a reflective material (not shown) along a surface associated with each electromagnetic radiation emitting device 502c, 504c, 506c which may aid in directing or otherwise focusing electromagnetic radiation towards an in process composite structure.

In various embodiments, any support structure of a radiative device (e.g., any of support structures 520a-520c) may be coupled to arm(s) or other positioning device(s) (not shown) that may allow a corresponding radiative device to be configured in one or more position(s), depending on implementations and/or applications.

The radiative device configurations illustrated in FIGS. 5A-5C are only a few of the many possible radiative device configurations that may be used in a fabrication system (e.g., fabrication system 300 of FIG. 3) in accordance with embodiments described herein and are not meant to limit the broad scope of the present disclosure. Although the radiative device configurations illustrated in FIGS. 5A-5C illustrate devices having one, two, or three sides, it is to be understood that some configurations may include four or more sides, depending on implementation and/or application. Virtually any other radiative device configurations may be provided using similar means and methods as those described herein and, thus, are clearly within the scope of the present disclosure.

The flowcharts and diagrams in the FIGURES illustrate the architecture, functionality, and operation of possible implementations of various embodiments of the present disclosure. It should also be noted that, in some alternative implementations, the function(s) associated with a particular block may occur out of the order specified in the FIGURES. For example, two blocks shown in succession may, in fact, be executed substantially concurrently, or the blocks may sometimes be executed in the reverse order or alternative orders, depending upon the functionality involved.

Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

As used herein, unless expressly stated to the contrary, use of the phrase ‘at least one of’, ‘one or more of’ and ‘and/or’ are open ended expressions that are both conjunctive and disjunctive in operation for any combination of named elements, conditions, or activities. For example, each of the expressions ‘at least one of X, Y and Z’, ‘at least one of X, Y or Z’, ‘one or more of X, Y and Z’, ‘one or more of X, Y or Z’ and ‘A, B and/or C’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms ‘first’, ‘second’, ‘third’, etc., are intended to distinguish the particular nouns (e.g., element, condition, module, activity, operation, etc.) they modify. Unless expressly stated to the contrary, the use of these terms is not intended to indicate any type of order, rank, importance, temporal sequence, or hierarchy of the modified noun. For example, ‘first X’ and ‘second X’ are intended to designate two X elements that are not necessarily limited by any order, rank, importance, temporal sequence, or hierarchy of the two elements. As referred to herein, ‘at least one of’, ‘one or more of’, and the like can be represented using the ‘(s)’ nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
forming a ply stack on a tool, the ply stack comprising a plurality of plies;
compacting the ply stack; and
heating the ply stack during the compacting to form a composite structure, wherein the heating is caused by an electromagnetic inductive device.

2. The method of claim 1, wherein compacting the ply stack further comprises:
encapsulating the ply stack within a bag; and
increasing a vacuum within the bag to increase external pressure on the bag and the composite structure.

3. The method of claim 2, wherein none of the plurality of plies comprises an electrically conductive material, and the bag comprises an electrically conductive material.

4. The method of claim 2, further comprising:
placing a foreign material layer on a surface of the ply stack prior to encapsulating the ply stack within the bag, wherein the foreign material layer is flexible and is at least one of a vacuum breather, a thermal insulator, and an electrical conductor.

5. The method of claim 2, further comprising:
placing a foreign material layer on a surface of the ply stack prior to encapsulating the ply stack with in the bag, wherein the foreign material layer is hard and is at least one of a stiff or semi-stiff caul, a thermal insulator, and an electrical conductor.

6. The method of claim 2, wherein at least one ply of the ply stack comprises an electrically conductive material.

7. The method of claim 6, wherein the electrically conductive material is at least one of a metal-based material or a carbon-based material.

8. The method of claim 6, wherein the electrically conductive material is included within a fiber structure of the at least one ply.

9. The method of claim 6, wherein the bag comprises an electrically conductive material.

10. The method of claim 6, further comprising:
providing a releasable material along one or more outer surfaces of the ply stack, wherein the releasable material comprises an electrically conductive material.

11. The method of claim 1, wherein the electromagnetic inductive device comprises a planar coil positioned to cover at least one of an outer surface or an inner surface of the ply stack.

12. The method of claim 1, wherein the electromagnetic inductive device comprises a helical coil that is to encircles at least one of an outer surface or an inner surface of the ply stack.

13. The method of claim 1, wherein the tool is a first tool, the method further comprising:
providing a second tool that covers the composite structure; and
curing the composite structure at another temperature that is different than a temperature associated with the heating performed during the compacting.

14. A method comprising:
forming a ply stack on a tool, the ply stack comprising a plurality of plies;
compacting the ply stack; and
heating the ply stack during the compacting to form a composite structure, wherein the heating is caused by a radiative device.

15. The method of claim 14, wherein compacting the ply stack further comprises:
encapsulating the ply stack within a bag; and
increasing a vacuum within the bag to increase external pressure on the bag and the composite structure.

16. The method of claim 15, wherein the bag comprises a material that increases electromagnetic radiation absorption for the bag.

17. The method of claim 14, wherein the radiative device is one of:
one or more heat lamps; or
one or more light emitting diodes.

18. The method of claim 14, further comprising:
applying a material along one or more surfaces of the ply stack, wherein the material increases electromagnetic radiation absorption for the ply stack along the one or more surfaces to which the material is applied, and the material is a spray on powder or liquid.

19. A system comprising:
a tool upon which a ply stack is formed;
a bag to form a sealed volume around the tool and the ply stack; and
a device to cause the ply stack to be heated using inductive or radiative heating.

20. The system of claim 19, wherein at least one of the bag or at least one ply of the ply stack comprises a conductive material, or wherein at least one of the bag is composed of a material that increases electromagnetic radiation absorption of the bag or at least one ply of the ply stack is coated along at least one surface with a material that increases electromagnetic radiation absorption of the at least one ply.
